(19) United States
(12) Patent Application Publication
(10) Pub. No.: US 2023/0232897 A1
(43) Pub. Date: Jul. 27, 2023

(54) ASHTRAY APPARATUS

(71) Applicant: YOEL BERMAN, BEER SHEVA (IL)

(72) Inventor: YOEL BERMAN, BEER SHEVA (IL)

(21) Appl. No.: 18/101,690

(22) Filed: Jan. 26, 2023

(30) Foreign Application Priority Data
Jan. 27, 2022 (IL) 290180

(51) Int. Cl. A24F 19/14; A24F 19/00

(52) U.S. Cl. CPC A24F 19/14; A24F 19/0021

(57) ABSTRACT

An ashtray apparatus (200), including a boreholes panel (12) having multiple boreholes (15), each for extinguishing a lighted cigarette (13) by placing the cigarette therein, a pistons panel (24) having a plurality of pistons (16), each correspondingly with one of the boreholes (15), and a mating mechanism, for mating the pistons with the boreholes, thereby allowing removing cigarette ash and butts from the apparatus at once rather than pulling each of the cigarettes one by one.

### TECHNICAL FIELD

The invention relates to the field of smoking aids.

### BACKGROUND

U.S. Pat. No. 2,100,263A discloses a combination of a barrel, a knob rotatably fitting one end of said barrel, a mouth extension rising vertically from the barrel and opening thereinto for accommodating a lighted cigarette, and a coil of wire fitted within said knob and snugly confined within said barrel for rotation therein by the knob and having a spread turn for bridging the communication between the mouth extension and said barrel for the snuffing of the lighted end of said cigarette when said cigarette is protruded through the mouth extension into the barrel and into the path of the spread turn.

FIG. 1a schematically illustrates an ashtray apparatus, according to the prior art.

FIG. 1b is a sectioned view an ashtray apparatus, according to the prior art.

The apparatus, which is marked by numeral 100, comprises an ashtray (ash receptacle) 10, having cigarette holders 11. Inside the ashtray 10 is disposed a boreholes panel 12 having boreholes 15. In order to extinguish a burned cigarette 13, the user inserts the cigarette with its burned edge into a free borehole, where it extinguishes as a result of absence of oxygen.

In order to empty the accumulated cigarettes and ash (14), the user extracts each of the cigarette butts from the ashtray, turns the apparatus 100 upside-down, and shakes it, as illustrated in FIG. 2. This procedure is cumbersome, and often the ash doesn't completely remove from the ashtray, for example due to humidity and the like. In order to clean better the boreholes, the user may wash the ashtray with water, use a stick to remove the ash stuck to the boreholes, etc.

It should be noted that the boreholes panel 12 is stationary, as illustrated in FIG. 1b.

The main disadvantage of the apparatus described above is their awkwardness.

All the methods described above have not yet provided satisfactory solutions to the problem emptying a combined ashtray and extinguisher apparatus.

### SUMMARY

In one aspect, the invention is directed to an ashtray apparatus (200), comprising, a boreholes panel (12) having a plurality of boreholes (15), each for extinguishing a lighted cigarette (13) by placing the cigarette therein, a pistons panel (24) having a plurality of pistons (16), each correspondingly with one of the boreholes (15), and a mating mechanism, for mating the pistons with the boreholes, thereby allowing removing cigarette ash and butts from the apparatus at once rather than pulling each of the cigarettes one by one.

According to one embodiment of the invention, the boreholes panel (12) is shiftable and the pistons panel (24) is stationary.

According to another embodiment of the invention, the pistons panel (24) is shiftable and the boreholes panel (12) is stationary.

According to one embodiment of the invention, the mating mechanism comprises a motor (19), for shifting the boreholes panel (12) towards the pistons panel (24).

According to one embodiment of the invention, the mating mechanism comprises a motor (19), for shifting the pistons panel (24) towards the boreholes panel (12) and back from it.

The ashtray apparatus may further comprise a button (20) for switching the apparatus from a normal state thereof to a cleaning state thereof, and vice versa.

The ashtray apparatus may further comprise a handle (22) connected to the boreholes panel or to the pistons panel, for switching the apparatus from a normal state thereof to a cleaning state thereof, and vice versa.

The ashtray apparatus may further comprise a light fixture (21), for illuminating an interior of the apparatus (200), thereby easing a use of the apparatus in dark.

The ashtray apparatus may be adapted to be installed indoors, outdoors, in a vehicle, etc.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF DRAWINGS

Embodiments, features, and aspects of the invention are described herein in conjunction with the following drawings:

FIG. 1a schematically illustrates an ashtray apparatus, according to the prior art.

FIG. 1b is a sectioned view an ashtray apparatus, according to the prior art.

FIG. 2 pictorially illustrates an operation of emptying ash from an ashtray apparatus, according to the prior art.

FIG. 3 schematically illustrates an ashtray apparatus, according to one embodiment of the invention.

FIG. 4a is a sectioned view of an ashtray apparatus, according to one embodiment of the invention.

FIG. 4b is a sectioned view of an ashtray apparatus, according to one embodiment of the invention.

FIG. 5 is a sectioned exploded view of a combined ashtray and extinguisher apparatus, according to one embodiment of the invention.

FIG. 6a schematically illustrates an ashtray apparatus in its normal state, according to one embodiment of the invention.

FIG. 6b schematically illustrates an ashtray apparatus in its cleaning state, according to one embodiment of the invention.

FIG. 7a is a sectioned view of an ashtray apparatus in a normal state, according to one embodiment of the invention.

FIG. 7b is a sectioned view of an ashtray apparatus in a cleaning state, according to this embodiment of the invention.

FIG. 8 is an exploded view of an ashtray apparatus 200, according to this embodiment of the invention.

FIG. 9a is a sectioned view of an ashtray apparatus in a normal state, according to one embodiment of the invention.

FIG. 9b is a sectioned view of an ashtray apparatus in a cleaning state, according to this embodiment of the invention.

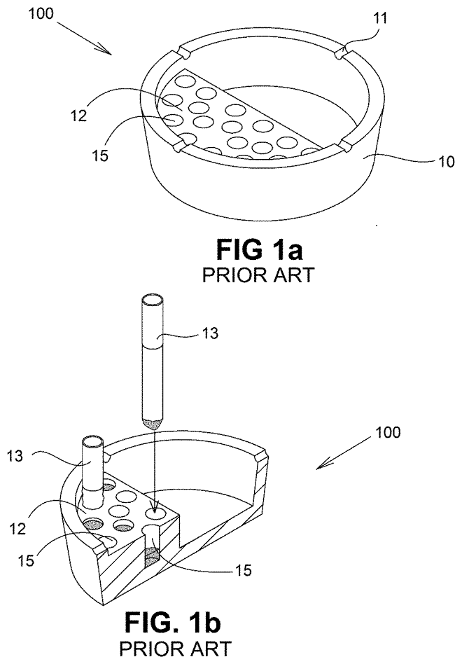

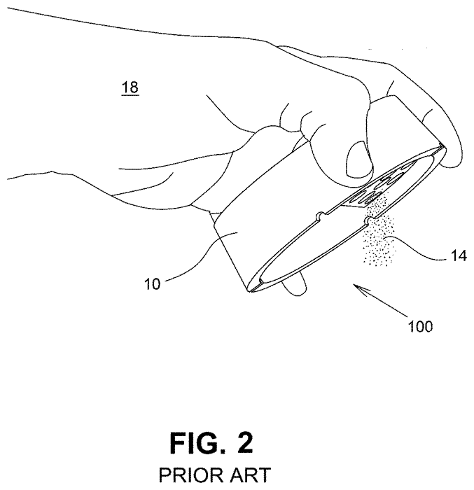

It should be understood that the drawings are not necessarily drawn to scale.

### DETAILED DESCRIPTION

The invention will be understood from the following detailed description of various embodiments which are meant to be descriptive and not limiting. For the sake of brevity, some well-known features, methods, systems, procedures, components, circuits, and so on, are not described in detail.

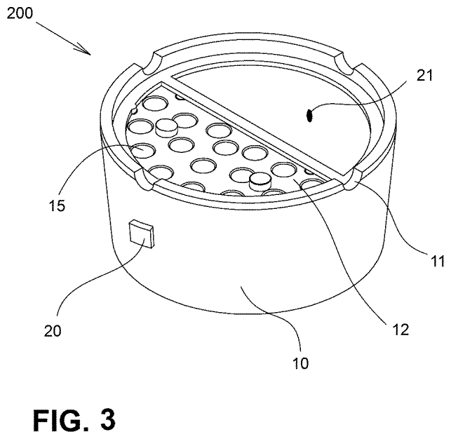

FIG. 3 schematically illustrates an ashtray apparatus, according to one embodiment of the invention.

The difference between apparatus 200 and apparatus 100 of the previous figures is the vertically shiftable boreholes panel 12, as detailed herein.

Reference numeral 20 denotes a button, for switching the apparatus 200 from its normal state to its cleaning state, and vice versa.

Reference numeral 21 denotes a light fixture, such as a LED, for lighting the apparatus 200, to let a user thereof to see the apparatus in poor light condition. The light fixture may be operated by a battery, or a chargeable battery by a solar panel (not shown).

The light fixture and the button are optional.

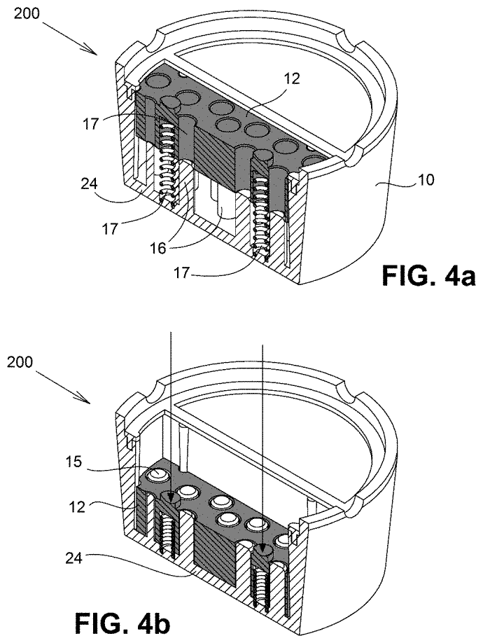

FIG. 4a is a sectioned view of an ashtray apparatus, according to one embodiment of the invention.

The apparatus, 200, comprises a vertically shiftable boreholes panel 12, and a stationary pistons panel 24, such that each of the pistons 16 of the pistons panel 24 corresponds with a borehole 15 of the boreholes panel 12.

One or more springs 17 retain the boreholes panel 12 in its up state, as illustrated in this figure. In the up state, which is referred herein as “normal state”, the ashtray device is ready for use by a smoking person.

FIG. 4b is a sectioned view of an ashtray apparatus, according to one embodiment of the invention.

By pushing the boreholes panel 12 downwards (see the arrows) such that the springs' objection is overcome, the pistons 16 push upwards (with relative to the ashtray) the ash and cigarette butts (not illustrated in this figure), which fall into the ashtray. In this situation, which is referred herein as “cleaning state”, the user turns the apparatus 200 upside-down and spills the ash and cigarette butts out from the ashtray apparatus.

In contrast to the prior art, where the user has to pull the cigarette butts one by one, according to this embodiment of the invention the user does not pull the butts, but rather pushes the boreholes panel downwards, which removes the butts and ash out of the boreholes. Thus, according to the invention, emptying the butts and ash from the apparatus 200 of the invention is carried out by simpler operations in comparison to the prior art.

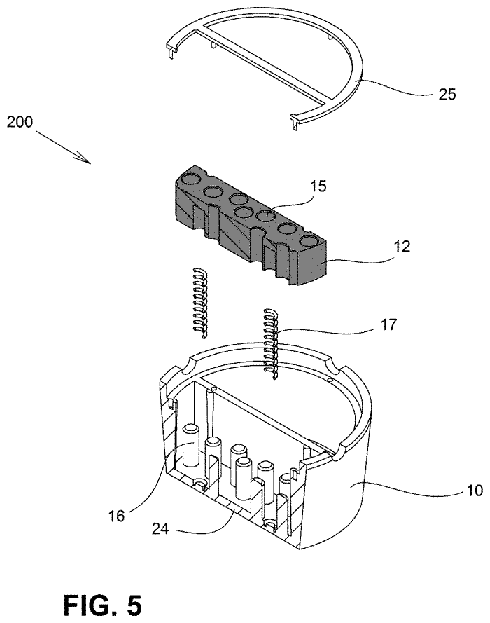

FIG. 5 is a sectioned exploded view of a combined ashtray and extinguisher apparatus, according to one embodiment of the invention.

It shows the ashtray (ash receptacle) 10, the boreholes panel 12, the springs 17, the pistons 16, and the corresponding boreholes 15. Numeral 25 denotes a frame which holds the parts together.

As mentioned, when boreholes panel 12 is pushed downwards, the pistons 16 mate with the corresponding boreholes 15m thereby pushing the cigarette butts and the ash in the boreholes outwards from the boreholes.

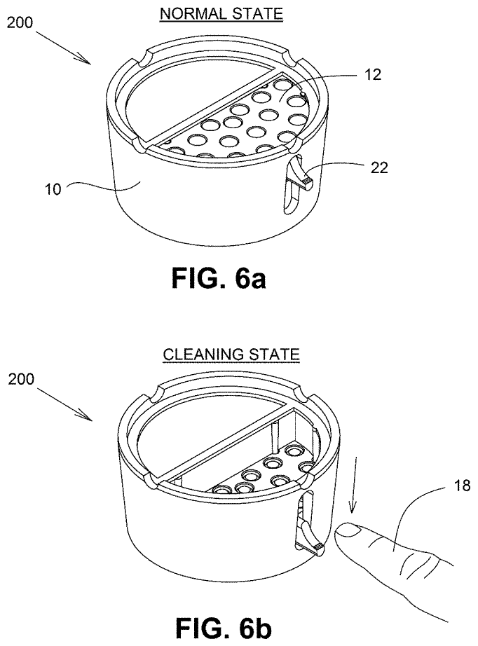

FIG. 6a schematically illustrates an ashtray apparatus in its normal state, according to one embodiment of the invention.

FIG. 6b schematically illustrates an ashtray apparatus in its cleaning state, according to one embodiment of the invention.

The ashtray apparatus comprises a mating mechanism between the pistons and their corresponding boreholes. According to this embodiment of the invention, a handle 22 is connected to the boreholes panel 12. Pushing handle 22 downwards pushes the boreholes of panel 12 towards the pistons 24, thereby causing the mating operation, which pushes ash and cigarette butts out of the boreholes.

In the normal state, i.e., the state in which apparatus 200 is in use, boreholes panel 12 is in its up state. A user may shift the boreholes panel 12 downwards by pushing handle 22 downwards, thereby causing the pistons to push out the cigarette butts and the ash in the boreholes.

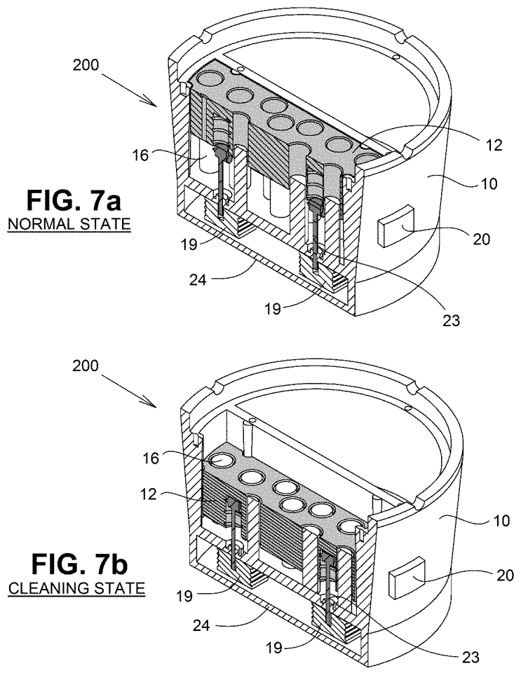

FIG. 7a is a sectioned view of an ashtray apparatus in a normal state, according to one embodiment of the invention.

FIG. 7b is a sectioned view of an ashtray apparatus in a cleaning state, according to this embodiment of the invention.

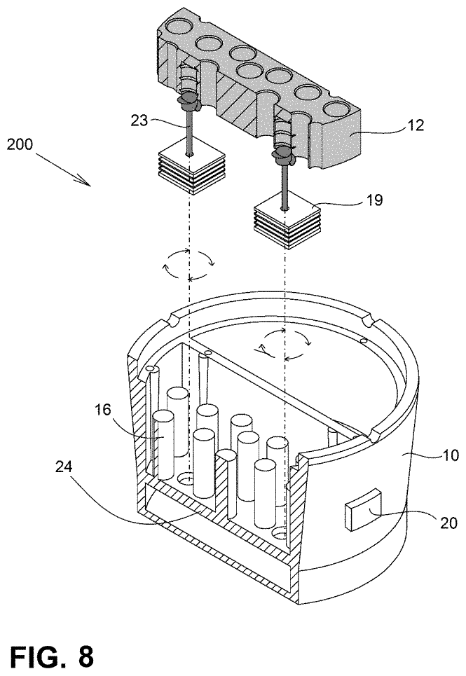

FIG. 8 is an exploded view of an ashtray apparatus 200, according to this embodiment of the invention.

The ashtray apparatus comprises a mating mechanism between the pistons and their corresponding boreholes. According to one embodiment of the invention, the mating operation is carried out by a motor that shifts the pistons towards the boreholes or vice versa.

In this example, the element that lifts/lowers the boreholes panel 12 is the pair of the electric motors 19. Switching from the normal state to the cleaning state and vice versa is activated by button 20.

For the sake of simplicity, in these figures motors 19 are illustrated as a solid object, without detailing the motor components, except the power shaft 23, which is actually a screw that threads in the boreholes panel.

In this figures a pair of electric motors are show. Actually, the number of motors is a matter of design.

Preferably, the motors operate by electric power of a battery (not illustrated).

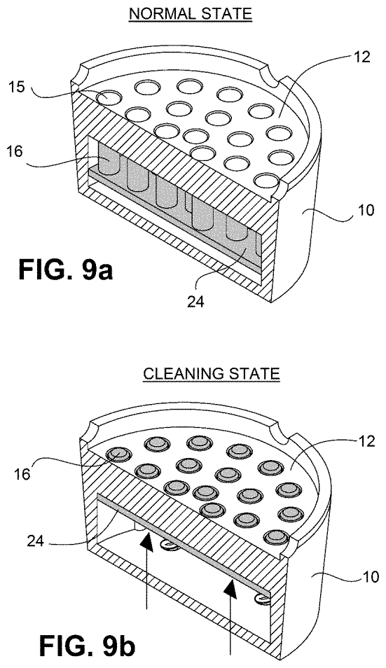

FIG. 9a is a sectioned view of an ashtray apparatus in a normal state, according to one embodiment of the invention.

FIG. 9b is a sectioned view of an ashtray apparatus in a cleaning state, according to this embodiment of the invention.

While in the embodiments described above the vertically shiftable element is the boreholes panel 12 and the stationary element is the pistons panel 24, according to this embodiment of the invention the vertically shiftable elements is the pistons panel 24, and the stationary element is the boreholes panel 12.

Switching from a normal state to a cleaning state and vice versa can be carried out by a motor, a handle connected to the pistons panel, etc. For the sake of simplicity these elements are not shown in FIGS. 9a and 9b.

The invention can be used both indoors and outdoors. When being used indoors, the outer bottom of the ashtray apparatus should be flat, or its legs (assuming it has legs) should be on the same plane, in order to be placed on a flat board such as table. For the purpose of using the invention in a vehicle, the ashtray apparatus can be installed in a niche inside the vehicle, attached to an interior wall of the vehicle, etc.

In the figures and/or description herein, the following reference numerals (Reference Signs List) have been mentioned:
numeral 10 denotes an ashtray (ash receptacle);
numeral 11 denote cigarette holders;
numeral 12 denotes a boreholes panel;
numeral 13 denotes a cigarette;
numeral 14 denotes ash;
numeral 15 denotes a borehole in boreholes panel 12;
numeral 16 denotes a piston (i.e., a metal cylinder which moves back and forth inside a cylinder, which is in this case a borehole of the boreholes panel 12);
numeral 17 denotes a spring that retains the apparatus in its normal state (i.e., ready for use);
numeral 18 denotes a user hand or finger;
numeral 19 denotes a motor;
numeral 20 denotes a button, for moving the boreholes panel 12/the pistons panel up/down;
numeral 21 denotes a light fixture, such as a LED (Light Emission Diode);
numeral 22 denotes a handle for shifting the boreholes panel 12/pistons panel 24 up/down;
numeral 23 denotes a power shaft of motor 19;
numeral 24 denotes a pistons panel; and
numeral 25 denotes a frame which holds the parts together.

In the description herein, the following references have been mentioned: U.S. Pat. No. 2,100,263A

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. An ashtray apparatus (200), comprising:
a boreholes panel (12) having a plurality of boreholes (15), each for extinguishing a lighted cigarette (13) by placing said cigarette therein;
a pistons panel (24) having a plurality of pistons (16), each correspondingly with one of said boreholes (15);
a mating mechanism, for mating said pistons with said boreholes,
thereby removing cigarette ash and butts from said apparatus at once rather than pulling each of said cigarettes one by one.

2. The ashtray apparatus according to claim 1, wherein said boreholes panel (12) is shiftable and said pistons panel (24) is stationary.

3. The ashtray apparatus according to claim 1, wherein said pistons panel (24) is shiftable and said boreholes panel (12) is stationary.

4. The ashtray apparatus according to claim 1, wherein said mating mechanism comprising a motor (19), for shifting said boreholes panel (12) towards said boreholes panel (12) and back from it.

5. The ashtray apparatus according to claim 1, wherein said mating mechanism comprising a motor (19), for shifting said pistons panel (24) towards said boreholes panel (12).

6. The ashtray apparatus according to claim 1, further comprising a button for switching said apparatus from a normal state thereof to a cleaning state thereof, and vice versa.

7. The ashtray apparatus according to claim 1, wherein said mating mechanism comprising a handle (22) connected to said boreholes panel (12), for approaching said boreholes panel (12) to said pistons panel (24).

8. The ashtray apparatus according to claim 1, wherein said mating mechanism comprising a handle (22) connected to said pistons panel (24), for approaching said pistons panel (24) to said boreholes panel (12).

9. The ashtray apparatus according to claim 1, further comprising a light fixture (21), for illuminating an interior of said apparatus (200), thereby easing a use of said apparatus in dark.

10. The ashtray apparatus according to claim 1, adapted to be installed in a member of a group consisting of: indoors, outdoors, in a vehicle.
